(19) United States
(12) Patent Application Publication
(10) Pub. No.: US 2016/0275462 A1
(43) Pub. Date: Sep. 22, 2016

(54) SYSTEM FOR MULTIPLE ACCOUNT SETTLEMENT

(71) Applicants: GIANNA CHRISTIANI, MCLEAN, VA (US); MICHAEL CHRISTIANI, MCLEAN, VA (US)

(72) Inventors: GIANNA CHRISTIANI, MCLEAN, VA (US); MICHAEL CHRISTIANI, MCLEAN, VA (US)

(21) Appl. No.: 15/071,847

(22) Filed: Mar. 16, 2016

Related U.S. Application Data
(60) Provisional application No. 62/133,617, filed on Mar. 16, 2015.

(51) Int. Cl. G06Q 20/10

(52) U.S. Cl. CPC G06Q 20/102

(57) ABSTRACT

A system for pre-approved alternate payors, including, but not limited to, parents, guardians, caregivers, or custodians, to pay for certain monthly charges on an underlying credit card holder's statement from a financial institution. The alternate payors may or may not also be banking customers of the issuing financial institution. The credit card holder selects a pre-approved alternate payor for a particular charge, and authorizes the system to send a payment request to the pre-approved alternate payor. Both the underlying credit card holder and the preapproved alternate payor approve each individual charge that will be debited from the alternate payor's specified account.

### SYSTEM FOR MULTIPLE ACCOUNT SETTLEMENT

This application claims benefit of and priority to U.S. Provisional Application No. 62/133,617, filed Mar. 16, 2015, and is entitled to that filing date for priority. The specification, figures, appendices and complete disclosure of U.S. Provisional Application No. 62/133,617 are incorporated herein in their entireties by specific reference for all purposes.

### FIELD OF INVENTION

This invention relates to a system and method allowing settlement of outstanding credit card charges or other credit balances by multiple financial institution customer accounts.

### BACKGROUND OF THE INVENTION

At present, only the owner of an underlying primary financial institution-issued credit card (e.g., Visa, MasterCard, Discover, and the like) is permitted to settle outstanding charges on the credit card electronically, typically through the issuing financial institution's web site using a web browser. Another customer of the same financial institution cannot settle any part of the credit card charges. Financial institutions only allow for the underlying credit card holder's bank account(s) (e.g., checking, savings) to be attached to the credit card account in order for electronic web-based payment of outstanding charges to be possible.

This arrangement is prohibitively cumbersome for parents, guardians, or other caregivers or custodians of children, parents, or other individuals to be able to pay off some or all of the outstanding charges where the credit card is held by or in the name of the child, parent or individual. Accordingly, what is needed is a means of allowing settlement of outstanding credit card charges or other credit balances by multiple financial institution customer accounts.

### SUMMARY OF INVENTION

The present invention allows for pre-approved alternate payors, including, but not limited to, said parents, guardians, caregivers, or custodians, to pay for certain monthly charges on the underlying credit card holder's statement from the financial institution. In one embodiment, the alternate payors must also be banking customers of the issuing financial institution. Both the underlying credit card holder and the preapproved alternate payor approve each individual charge that will be debited from the alternate payor's specified account.

In several exemplary embodiments, the process of the present invention proceeds as follows. First, the card holder receives a regular mail or electronic notification (by email, text, or other form of electronic communication) that the monthly credit card statement is available online. After logging into the website of the issuing financial institution, the holder views the statement of outstanding charges and credits to the credit card. The credits and charges can be settlement through the holder's checking or savings account, as is the practice at present. However, in accordance with the present invention, the holder also has the ability to select an alternate payor that has been preapproved. A list of preapproved alternate payors may be presented as a drop-down list.

The holder selects a desired alternate payor, and can authorize that payor for one or more certain specific charges on the statement. A general authorization for payment in general also may be provided. The alternate payor receives an email or other electronic notification to log into their account online with the issuing financial institution, where they receive information that payment of certain credit charges (or general payment) has been requested or assigned to them by the holder. The alternate payor can then decide to approve or disapprove of each specific charge that has been assigned to them by holder.

The sum of charges approved by the alternate payor is then debited from the checking or savings account with the financial institution, on a payment date that they select (which typically is before the credit card payment due date). These accounts may be pre-assigned, and preapproved.

The holder can choose multiple alternate payors for various charges. After all selections, the holder can continue by paying the remaining part of the statement. The holder, however, remains responsible for all outstanding charges. Alternate payors are not financially responsible for the credit card in any way, but simply have the ability for certain outstanding charges on the card. If payments are not made by an alternate payor, the holder is notified and must make payment directly or select another alternate payor for a particular charge.

### BRIEF DESCRIPTION OF THE DRAWINGS

FIG. 1 shows an example of a log-in page on a financial institution webpage.

FIG. 2 shows an example of an accounts summary and selection screen.

FIG. 3 shows an example of an account statement screen.

FIG. 4 shows an example of an individual transaction list with drop-down menu for pre-approved alternate payors.

FIG. 5 shows an example of an alternate payor payment screen.

### DETAILED DESCRIPTION OF EXEMPLARY EMBODIMENTS

The present invention provides for pre-approved alternate payors, including, but not limited to, parents, guardians, caregivers, or custodians, to pay for certain monthly charges on an underlying credit card holder's statement from a financial institution. In one embodiment, the alternate payors must also be banking customers of the issuing financial institution. Both the underlying credit card holder and the preapproved alternate payor approve each individual charge that will be debited from the alternate payor's specified account.

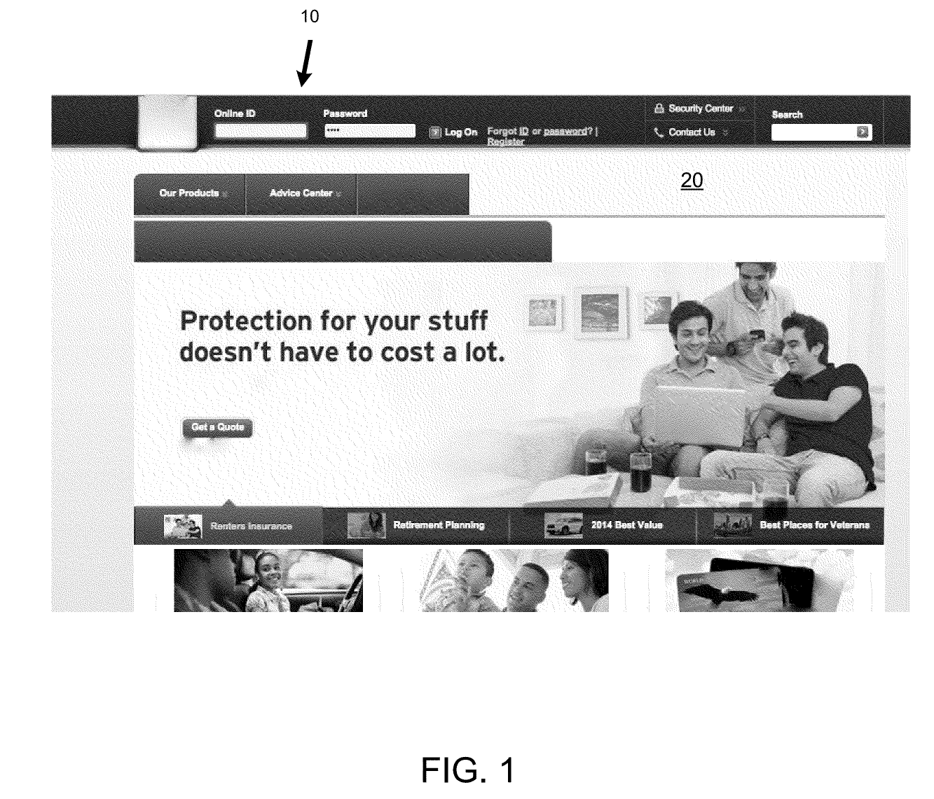

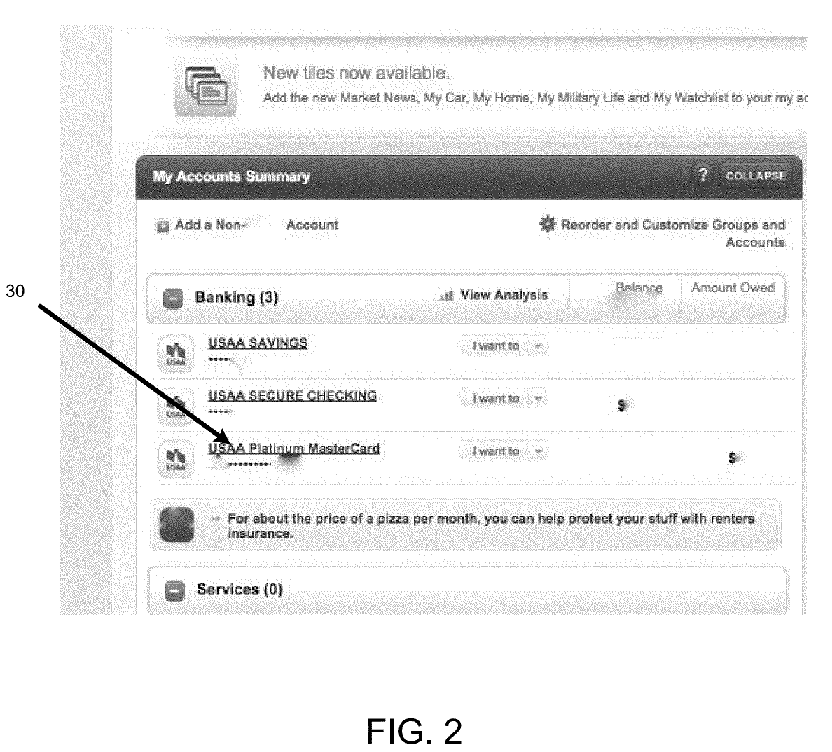

In several exemplary embodiments, the process of the present invention proceeds as follows. First, the card holder receives a regular mail or electronic notification (by email, text, or other form of electronic communication) that the monthly credit card statement is available online. As seen in FIGS. 1 and 2, after logging into 10 the website 20 of the issuing financial institution, the holder selects the desired card account 30 to view the statement of outstanding charges and credits to the credit card. The credits and charges can be settlement through the holder's checking or savings account, as is the practice at present.

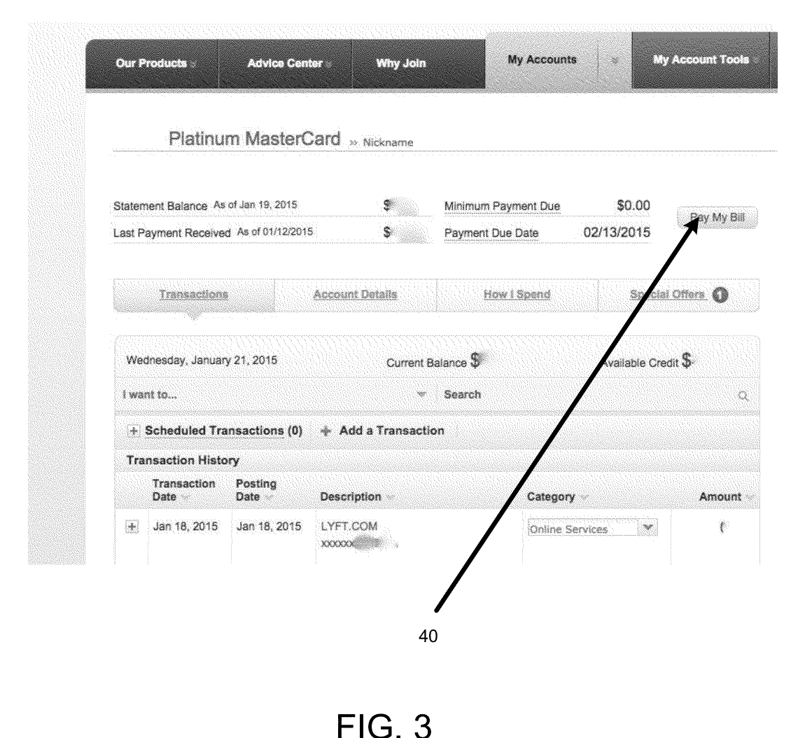

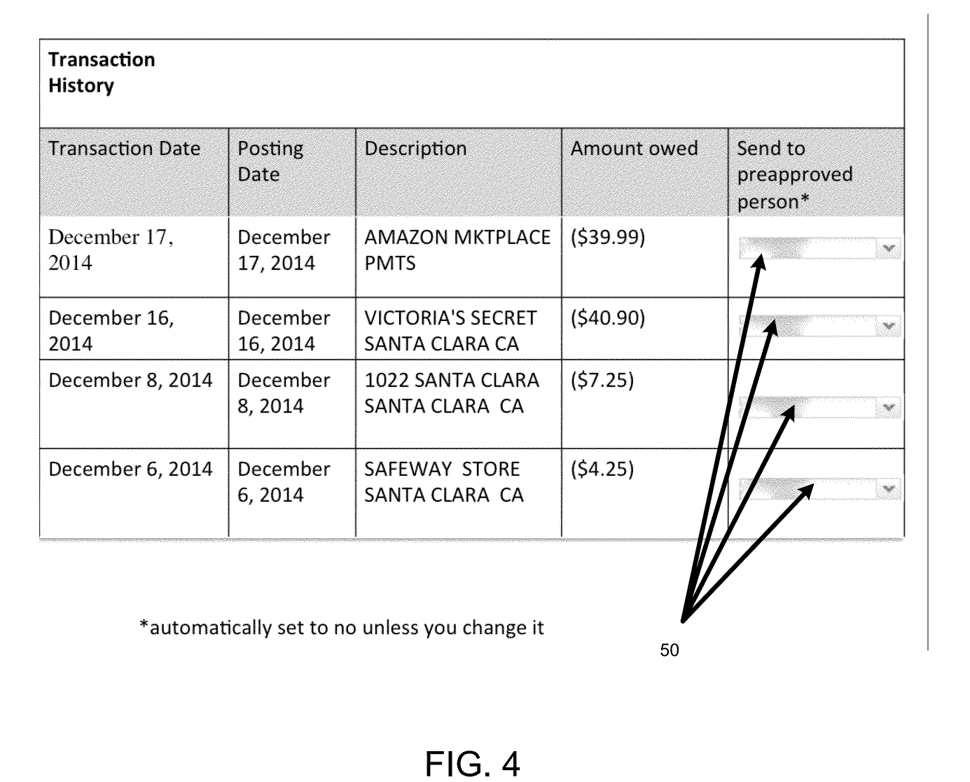

However, in accordance with the present invention, the holder also has the ability to select an alternate payor that has been preapproved. From the account statement screen, as seen in FIG. 3, the holder selects the “pay my bill” option 40. As seen in FIG. 4, the holder is presented a list of individual transactions, with an option to send the transaction to a pre-approved alternate payor for payment of that particular transaction 50. A list of preapproved alternate payors may be presented as a drop-down list. The option to send the transaction to a pre-approved alternate payor may default to “none” or “no”.

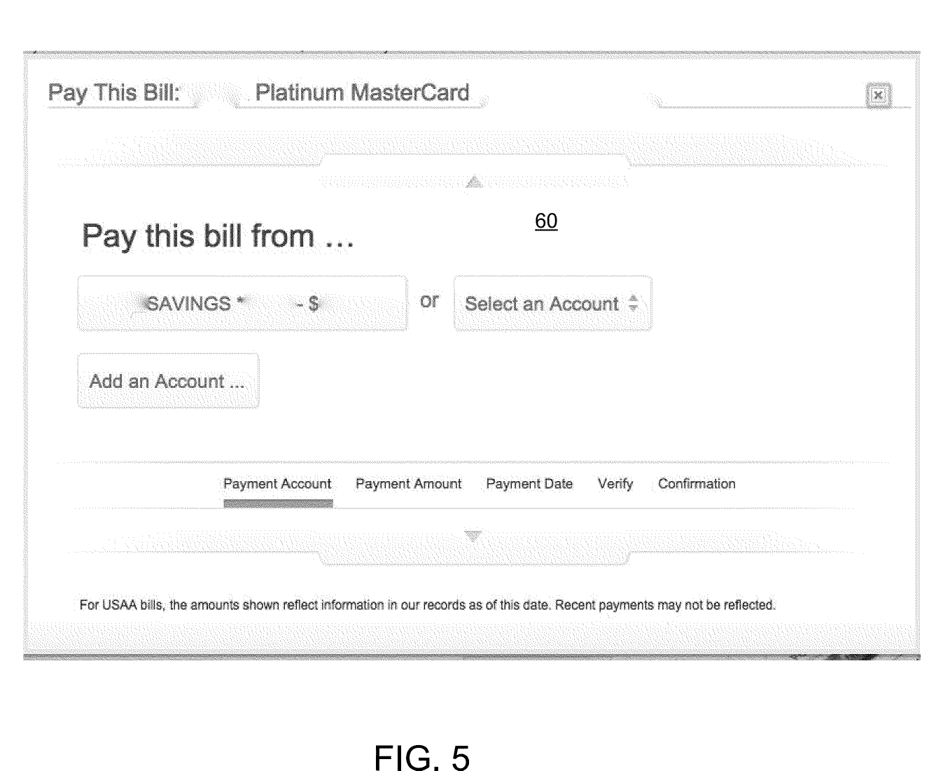

The holder selects a desired alternate payor, and can authorize that payor for one or more certain specific charges on the statement. A general authorization for payment in general also may be provided. The alternate payor receives an email or other electronic notification to log into their account online with the issuing financial institution, where they receive information 60 that payment of certain credit charges (or general payment) has been requested or assigned to them by the holder, as seen in FIG. 5. The alternate payor can then decide to approve or disapprove of each specific charge that has been assigned to them by holder.

The sum of charges approved by the alternate payor is then debited from the checking or savings account with the financial institution, on a payment date that they select (which typically is before the credit card payment due date). These accounts may be pre-assigned, and preapproved.

The holder can choose multiple alternate payors for various charges. After all selections, the holder can continue by paying the remaining part of the statement. The holder, however, remains responsible for all outstanding charges. Alternate payors are not financially responsible for the credit card in any way, but simply have the ability for certain outstanding charges on the card. If payments are not made by an alternate payor, the holder is notified and must make payment directly or select another alternate payor for a particular charge.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for improving online payment of account charges, comprising:
reviewing, on a display screen, a list of account charges for a selected account with a first financial institution;
selecting, using a processor or microprocessor, for a first account charge from said list of account charges, a pre-approved alternate payor; and
approving sending of an electronic notification to said pre-approved alternate payor soliciting payment of said first account charge.

2. The method of claim 1, wherein there are multiple pre-approved alternate payors.

3. The method of claim 1, wherein the pre-approved alternate payor also has an account with said first financial institution.

4. The method of claim 1, wherein the pre-approved alternate payor has pre-authorized payment of said first account charge.

5. A method for improving online payment of account charges, comprising:
providing to a user, on a display screen, a list of account charges for a selected account of the user with a first financial institution;
prompting, using a processor or microprocessor, the user to select a first account charge from said list of account charges, and a pre-approved alternate payor for said first account charge;
sending an electronic notification to said pre-approved alternate payor soliciting payment of said first account charge; and
receiving payment for said first account charge.

6. The method of claim 5, wherein there are multiple pre-approved alternate payors.

7. The method of claim 5, wherein the pre-approved alternate payor also has an account with said first financial institution.

8. The method of claim 5, wherein the pre-approved alternate payor has pre-authorized payment of said first account charge.

9. A system for improving online payment of account charges, comprising:
a microprocessor coupled to a memory, wherein the microprocessor is programmed to:
display a list of account charges for a selected account of a first user with a first financial institution;
prompt the first user to select, for a first account charge from said list of account charges, a pre-approved alternate payor; and
send an electronic notification to said pre-approved alternate payor soliciting payment of said first account charge.

10. The system of claim 9, wherein there are multiple pre-approved alternate payors.

11. The system of claim 9, wherein the pre-approved alternate payor also has an account with said first financial institution.

12. The system of claim 9, wherein the pre-approved alternate payor has pre-authorized payment of said first account charge.
